(19) United States
(12) Patent Application Publication
(10) Pub. No.: US 2016/0221027 A1
(43) Pub. Date: Aug. 4, 2016

(54) Brush and Methods of Use

(71) Applicant: Gardner-Gibson, Inc., Tampa, FL (US)

(72) Inventors: Amir G. Khan, Valrico, FL (US); Sean Hyer, Tampa, FL (US)

(73) Assignee: Gardner-Gibson, Inc.

(21) Appl. No.: 14/839,148

(22) Filed: Aug. 28, 2015

Related U.S. Application Data
(60) Provisional application No. 62/046,594, filed on Sep. 5, 2014.

(51) Int. Cl. B05C 17/02; A46B 7/04; A46B 5/00

(52) U.S. Cl. CPC B05C 17/0207; A46B 5/0095; A46B 7/04; A46B 7/042; A46B 7/046

(57) ABSTRACT

A brush for applying a viscous coating to surfaces such as a driveway, has a composition and conformation promoting an even application of the coating. The brush has bristles of a given, number, density/spatial distribution, free length, thickness and elastic modulus that in combination provide a controlled leakage of viscous coating past the brush when the handle thereof is held at a given angle and subjected to a given downforce to facilitate applying the coating.

### CROSS REFERENCE TO RELATED APPLICATIONS

This application claims the benefit of U.S. Provisional Application No. 62/046,594, entitled Brush and Methods of Use, filed Sep. 5, 2014, which is incorporated by reference herein in its entirety.

### FIELD

The present invention relates to brushes, and more particularly, to brushes used as applicators for coatings applied to surfaces.

### BACKGROUND

Various brushes and applicators are known for use in applying coatings, such as paint, glues, topcoats, etc. Notwithstanding, improved and/or alternative brush designs and methods for using them remain desirable for various applications.

### SUMMARY

The disclosed subject matter relates to a brush for applying viscous coatings. In one approach, the coating may be in the range of 2,500 CPS to 15,000 CPS and the brush has a brush head with a plurality of bristles having a modulus of elasticity in the range of 2-4 GPa, a diameter in the range of 0.25 mm to 1.0 mm and a free length of 1.5-2.5 inches. The overall brush thickness may be in the range of 0.75 inch to 1.0 inch. The brush may have a total bristle count of 2,500 to 3,500 and a width to thickness to height ratio in the range of 20:1.5:1.5 to 30:0.75:2.5.

In accordance with one aspect of the disclosure, The brush has a handle attached s to the brush head at an angle such that when the handle is held at an angle in the range of 10 to 40 degrees relative to the surface to be coated, the surface of the brush head defined by the terminal ends of the plurality of bristles is substantially flat on the surface +/−15 degrees.

In accordance with one aspect of the disclosure, an inner angle between the handle and the brush is about 120 degrees.

In accordance with one aspect of the disclosure, the brush head has a root portion with upper and lower portions, the lower portion attached to the bristles, the upper portion disposed at an inside angle of about 150 degrees relative to the lower portion, the handle connecting to and forming an angle of approximately 90 degrees relative to the upper portion.

In accordance with one aspect of the disclosure, the bristles are bent around a wire and crimped in a frame, the frame being attached to the root portion.

In accordance with one aspect of the disclosure, the bristles are nylon.

In accordance with one aspect of the disclosure, a support web extends between the handle and the brush head.

In accordance with one aspect of the disclosure, the inside angle between the bristles and the handle is about 120 degrees.

In accordance with one aspect of the disclosure, the brush head is attached to the handle by a tab and mating slot.

In accordance with one aspect of the disclosure, the brush head is attached to the handle by a mating sleeve and cylinder.

In accordance with one aspect of the disclosure, the brush head has a clamp for removably retaining a crimped metal frame in which the bristles are retained, the clamp removably attaching to the handle.

In accordance with one aspect of the disclosure, the brush head is attached to the handle by a mating threaded end of the handle received in a threaded aperture in the brush head.

In accordance with one aspect of the disclosure, the brush is capable of applying coatings in the viscosity range of 2,500 CPS to 15,000 CPS.

In accordance with one aspect of the disclosure, the film of the coating applied when the brush has an applied downforce of about 2 to 10 lbs. is between 25 to 50 mils.

In accordance with one aspect of the disclosure, the brush is capable of applying an even coating to a surface which has a roughness of about ⅛ inch without skips.

In accordance with one aspect of the disclosure, the bottom surface of the brush head has a surface area of about 18 inches².

In accordance with one aspect of the disclosure, the bottom surface of the brush is substantially parallel to the surface to which the coating is applied when the handle is at 30 degrees relative to the surface to which the coating is applied.

In accordance with one aspect of the disclosure, the brush is capable of applying the viscous coating when pushed or pulled.

In accordance with one aspect of the disclosure, the root portion has an upper channel and a lower channel, the lower channel receiving the frame and the upper channel having a fastener that couples to a bracket on the handle.

In accordance with one aspect of the disclosure, further including a frame fastener extending into the lower channel retaining the frame portion within the lower channel.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is side view of a brush in accordance with an embodiment of the present disclosure in three alternative orientations relative to a surface.

FIG. 2 is an enlarged view of the brush of FIG. 1 showing the angular orientations of a face of the brush relative to the surface in the three orientations of FIG. 1.

FIG. 3 is an exploded view of a brush in accordance with another embodiment of the present disclosure.

FIG. 4 is side view of the brush of FIG. 3.

FIG. 5 is a cross-sectional view of the brush of FIG. 4 taken along line 5-5 and looking in the direction of the arrows.

FIG. 6 is a perspective view of a brush in accordance with another embodiment of the present disclosure.

FIG. 7 is a top view of the brush of FIG. 6.

FIG. 8 is an exploded view of a brush in accordance with another embodiment of the present disclosure.

FIG. 9 is an exploded view of a brush in accordance with another embodiment of the present disclosure.

FIG. 10 is an exploded view of a brush in accordance with another embodiment of the present disclosure.

### DETAILED DESCRIPTION OF EXEMPLARY EMBODIMENTS

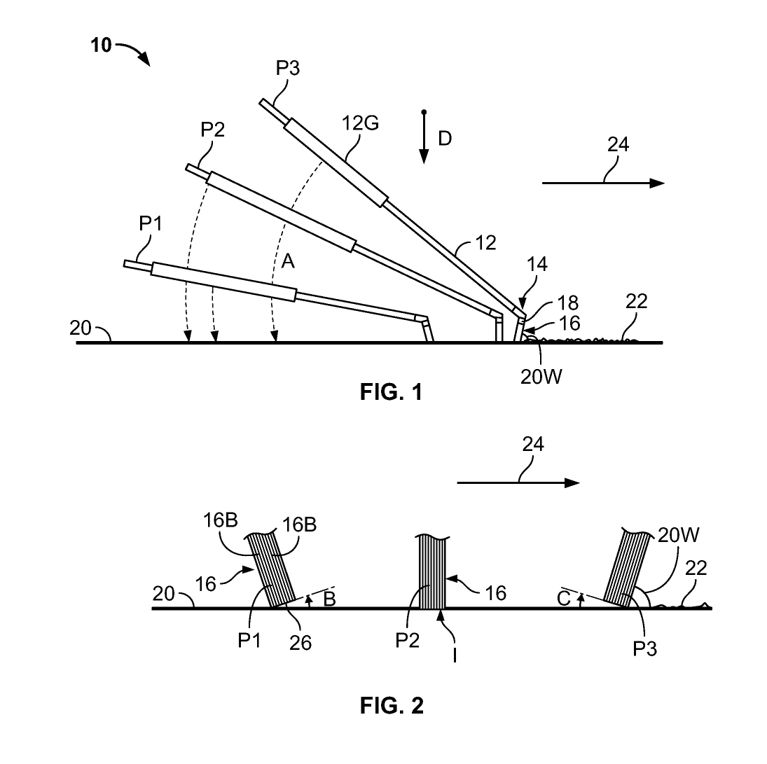

FIGS. 1 and 2 shows a brush 10 with an elongated handle 12 made from wood, metal or plastic. A rubber/foam grip 12G may be disposed on the handle 12 to soften the gripping surface for the hands of the user and/or to improve the grip that the user has on the handle 12. The handle 12 is attached to a brush head 14 that features a bristle portion 16 having a plurality of bristles 16B held within a bristle holder 18. The brush 10 may be used to apply a coating 20, such as driveway sealer or coating to a surface 22, such as an asphalt or blacktop driveway. In applying the coating 20, the brush may be held with the handle 12 at an angle A of, e.g., 10 to 40 degrees relative to the surface 22 and pushed by the user, forming a wave 20W of coating 20 at the front of the brush 10 in the direction 24 that the brush 10 is pushed. The bottom surface 26 formed by the bristles 16 is maintained approximately parallel to surface 22 (position P2), varying from angle B of about 15 degrees with the brush tilted back (position P1) to angle C of 15 degrees with the brush tilted forward (position P3), as the brush 10 is pushed over surface 22 to apply the coating 20. When pushed along a surface 22 with a component of force D (down pressure) directed perpendicular to the surface 22 of about 2 to 10 pounds, the bristles 16B are of a number and strength such that the bristles 16 curve only slightly at the tip. This type and level of bristle 16B response to the pushing of the brush 10 interacts favorably when the brush 10 is used to apply a viscous coating 20 to a surface 22, such as a driveway, which is anticipated to have a degree of surface roughness attributable to coarse aggregate, e.g., crushed 2 0 stone. In addition to a pushing motion in direction 24, the brush may be pulled in the opposite direction, to spread the coating on the surface. When being pushed or pulled, the brush 10 engages the surface 22 closely enough to form a partial “seal” with the surface 22, allowing a layer of coating 20 of an appropriate thickness to escape past the interface I between the brush 10 and the surface 22 and remain on the surface 22 after the brush 10 has passed over it. The “seal” formed at the interface I has a controlled “leakage,” which generates the coating layer 20 of appropriate thickness. The remainder of the coating 20 which does not pass through interface I, is pushed as a wave 20W in front of the brush 10. In traversing the rough surface 22, the bristles 16B have sufficient flexibility to accommodate the roughness of the surface 20 by localized bending without breaking the overall “seal” of the brush 10 to the surface 20.

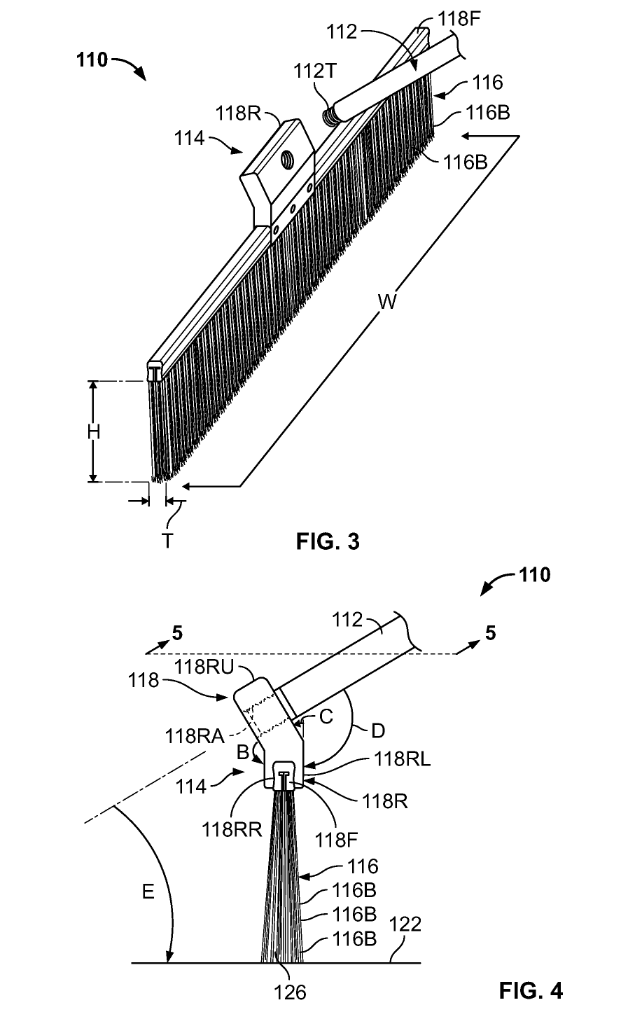

FIGS. 3 and 4 show a brush 110 in accordance with an embodiment of the present disclosure. The brush 110 has a handle 112 with a threaded end 112T. The brush head 114 has a bristle portion 116 having dimensions approximating twenty-four (24) inches in width W, three-quarters (¾) inch in thickness T at the bottom surface 126, and two (2) inches in free length/height H, resulting in a dimensional ratio of width to thickness to height (W:T:H) of 24:3/4:2 and bottom surface 126 having a surface area of 24*0.75=18 inches². The bristle holder 118 has a root portion 118R which is attached to a frame portion 118F. The frame portion 118F may be formed from sheet metal, e.g., steel, that is formed into a channel shape into which the bristles 116B may be inserted and then the frame portion 118F crimped down to retain the bristles 116B. The root portion 118R has a recess 118RR to receive the frame portion 118F therein, where it may be spot welded or otherwise attached, e.g., by sheet metal screws or an adhesive such as epoxy, to the root portion 118R. The root portion 118R may be provided with an aperture 118RA to receive a handle 112 and both the handle 112 and the aperture 118RA may be threaded to be matingly and threadedly attached. The root portion 118R may have an upper portion 118RU that is angularly offset from a lower portion 118RL, i.e. by inside angle B of about 150 degrees corresponding to outside angle C of about 30 degrees. The handle 112 may insert into the upper portion 118RU at approximately 90 degrees, resulting in an angle D between the lower portion 118RL and the handle 112 of about 120 degrees. In this configuration, the bottom surface 126 of the bristle portion 116 will be substantially parallel to the surface 122 when the handle 112 is held at an angle E of about 30 degrees relative to the surface 122.

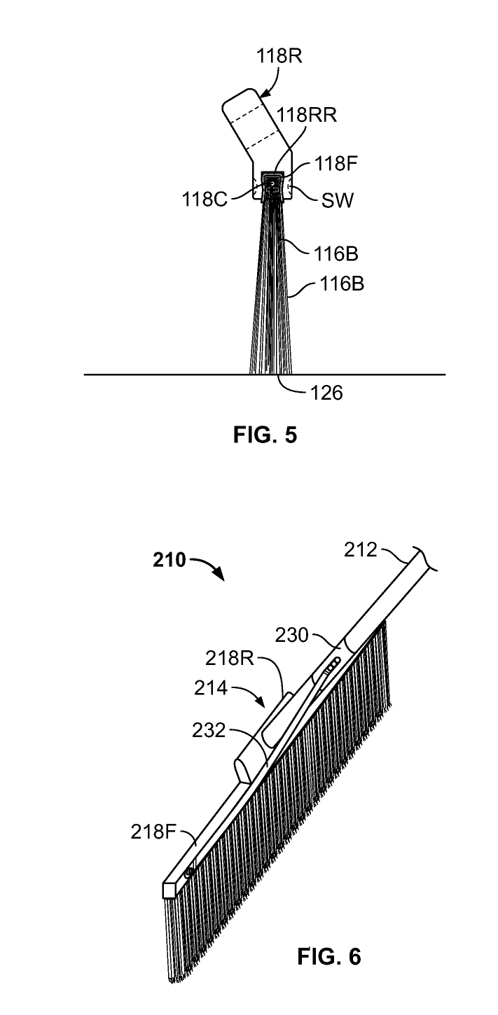

The individual bristles 116B may be made from a resilient material, such as nylon, which is compatible for use with the compounds and coatings it is intended to apply, e.g., asphaltic compounds and coatings, such that the solvents used to maintain such compositions in a flowable state would not dissolve the bristles 116B. The same considerations apply to the bristle holder 118, in that it can not be compromised, e.g., softened by the coating that the brush 110 is intended to apply. The bristles 116B have a cylindrical cross-sectional shape with a diameter in the range of 0.25 mm to 1.0 mm and an overall length of about 2.0 to 3.0 inches, e.g., 2.5 inches (63.5 mm), 2.0 inches (50.8 mm) of which is free length and the remainder is captured in the frame portion 118F. As shown in FIG. 5, the bristles 116B may be retained in the frame portion 118F by a core 118C, e.g., a wire, each bristle 116B being bent into a U-shape over the core 118C. This form of construction ensures that the bristles 116B are securely retained in the bristle holder 118 along the entire width of the bristle portion 116. If the individual bristles 116B are made from nylon (typically having an elastic modulus E in the range of 2-4 GPa), the stiffness of each bristle 116B may be calculated, e.g., k=(A (cross-sectional area)*E (elastic modulus))/L (length). If the total number of bristles 116B (counting both sides of a U-shaped bristle bent over a core 118C) is in the range 2500 to 3500 then the resultant cumulative stiffness k_{C}=k*total number of bristles. If the surface area of the bottom surface 126 is in the range of 15 inches² to 25 inches², then the stiffness per inch² may also be calculated. In accordance with an embodiment of the present disclosure, a brush 110 having a dimensional ratio of width to thickness to height (W:T:H) in the range of 20:1.5:2 to 30:0.75:2.5 made with nylon bristles having the dimensions and density described above will exhibit suitable bristle deformation and suitable leakage past the brush 110 when applying coatings having a viscosity in the range of 2500 CPS to 15000 CPS. A down force in a range of 2 to 10 lbs. may be applied on a handle 112 disposed at an angle in the range of 10 to 40 degrees relative to the surface 122 to which the coating 120 is applied. This results in a leakage past the brush 110 that effectively applies the coating 120 to the surface 122.

FIG. 6 shows a brush 210 where the brush head 214 is supported by a sleeve 230 disposed about the handle 212 and braces 232 that attach to and extend from the sleeve 230 to the frame portion 218F.

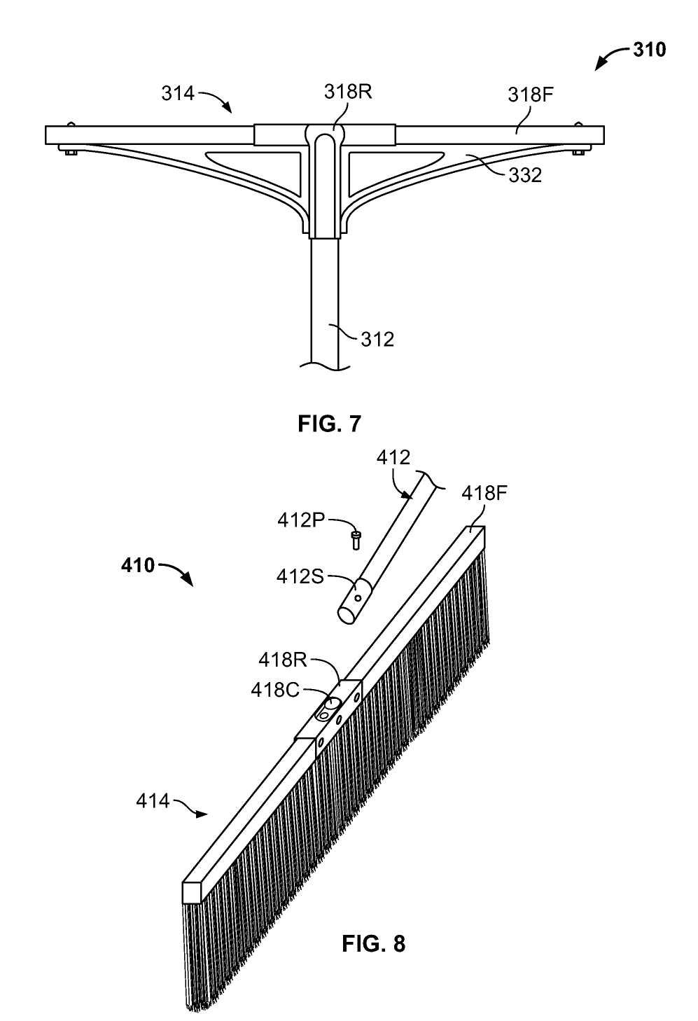

FIG. 7 shows a brush 310 with a brush head 314 having a support web 332 that may be formed from stamped metal or molded plastic. The web intermediates between and attaches to the root portion 318R into which a handle 312 is received and to the frame portion 318F of the brush head 314.

FIG. 8 shows a brush 410 with a brush head 414 to which is attached a root portion 418R. The root portion 418R has an attachment cylinder 418C that extends up from the root portion 418R at an angle and is received in a coupling sleeve 412S that is attached to the handle 412. A rivet or screw 412P may be used to retain the sleeve 412S on the cylinder 418C. The root portion 418R may be spot welded, screwed or otherwise attached to frame portion 418F.

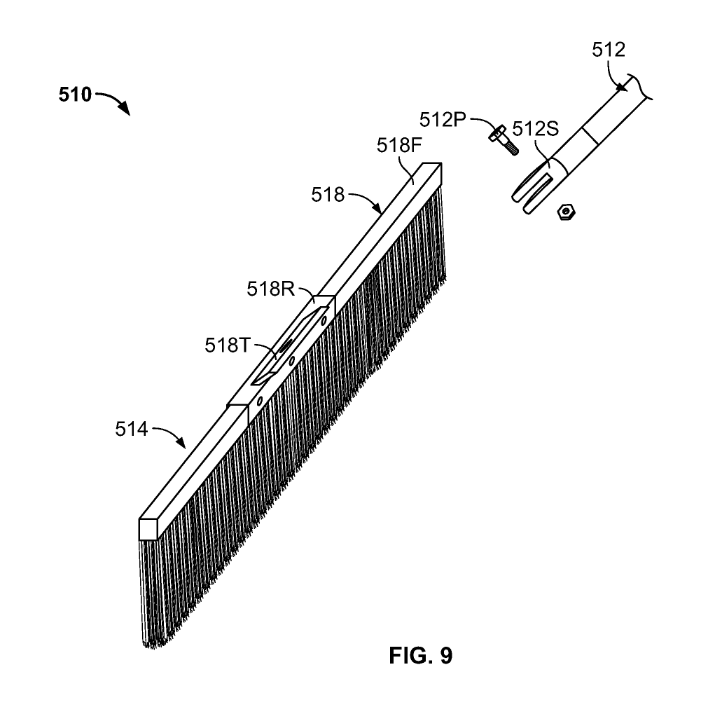

FIG. 9 shows a brush 510 with a brush head 514. The bristle holder 518 has a root portion 518R. The root portion 518R has an attachment tab 518T that extends up from the root portion 518R at an angle and is received in a slotted coupling 5125 that is attached to the handle 512. One or more rivets or bolts/nuts 512P may be used to retain the coupling 5125 on the tab 518T. The root portion 518R may be spot welded, screwed or otherwise attached to frame portion 518F.

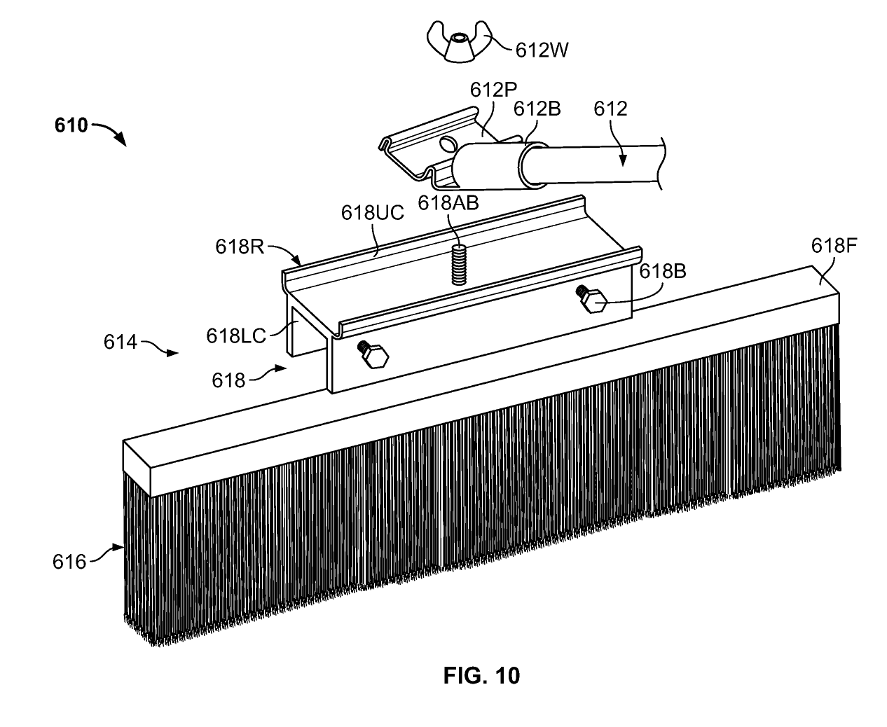

FIG. 10 shows a brush 610 with a brush head 614 and a bristle holder 618 with a root portion 618R. The root portion 618R has a lower channel 618LC that can receive the frame portion 618F. One or more bolts 618B can be tightened down to grip the frame portion 618F and retain it the lower channel 618LC. An attachment bolt 618AB that extends up from the root portion 618R and is received in a coupling plate 612P that extends from a coupling bracket 612B which attaches to the handle 612. The bracket 612B may be glued, threadedly coupled, bolted or riveted to the handle 612. A wing nut 612W may be used to retain the plate 612P to the root portion 618R via attachment bolt 618AB. The plate 612P may be shaped to mate with the surface of the upper channel 618UC. The brush 610 allows the bristle portion 616 to be replaced without disposing of the remainder of the brush head 614.

### EXAMPLE 1

A driveway sealer made from asphalt typically has a viscosity in the range of 2,500 to 15,000 CPS. The desired coating thickness or film to be applied with a driveway sealer of this type is 50 mils in total thickness. The total thickness of driveway sealer may be applied in 2 separate passes or coats which are allowed to dry between coats. In this example, the desired thickness for each coat of sealer is therefore 25 mils. Preferably, the coating applied will not exceed 50 mils in thickness for each coat and each coat will be substantially even. A brush 10 having attributes in accordance with the present disclosure was used to apply a coating of driveway sealer obtained from Gardner-Gibson and known by the brand Ultramaxx 1000. The bristle portion 16B had the following dimensions: Width: 24 inches, Height (bristle free length): 2.5 inches, Thickness: 0.75 inches, having 130 bristles/inch, i.e., 3120 bristles full width of the 24 inch wide bristle portion 16. The sealer had a measured viscosity of 8000 CPS at 77° F. The sealer was applied to a flat blacktop driveway having a surface roughness of about ⅛″ irregular. The temperature of the driveway surface at the time of application was 90° F. The handle 12 of the brush 10 was 5 feet long and held at an angle of about 30 degrees. The brush head 14 was weighted with a weight of ½ lb to generate a constant down force. A puddle of sealer having a volume of about 2 gallons was poured in front of the brush 10 and the brush 10 was advanced a distance of 20 feet in about 1 minute. Upon inspection, the coating 20 was applied with no skips or bare spaces in the coating layer. The area coated exhibited comprehensive coating of the rough surface, including low spots (valleys between aggregate) and high spots (at the points of the aggregate that extend upwardly). The coating of sealer was allowed to dry and the thickness of the coating was measured at various points on the coated surface and was found to be about 21 mils thick, varying by no more than about 5% over the coated surface.

A brush 10, 110, 210, etc. in accordance with the present disclosure and used in accordance with the present disclosure functions like a squeegee when applying a viscous coating material. The bristles 16B are firmly held and closely arranged together preventing passage of the coating 20 through the upper part of the bristle portion 16, proximate the bristle holder 18. The bristles 16B do not bend excessively under the down force D typically required to advance the brush 10 over a surface 22 while applying viscous coating 20 on the surface 22. The action of the brush 10 in pushing the coating 20 allows the coating 20 to penetrate nooks and crevasses in a rough surface, such as a blacktop driveway and maintains even coating over the area of application. When used for spreading a viscous coating 20, the bristle portion 16 maintains its shape, in that the edges do not curl up.

In applying high viscosity coatings ranging from 2500 CPS to 15000 CPS, the brush 10 is able to adapt to the changing down force D required to spread the coating 20 without distortion of the bristles 16B. The rubber/foam sleeve(s) 14 on the handle 12 allows the handle 12 to be gripped firmly without slipping and increases control of the user over the brush 10, as well as reducing fatigue for the user. The brush 10 allows the user to redirect the brushing direction 24 by any angle, e.g., 90 or 180 degrees and still push the coating 20 in a continuous layer without gaps in coverage.

It will be understood that the embodiments described herein are merely exemplary and that a person skilled in the art may make many variations and modifications without departing from the spirit and scope of the present application. All such variations and modifications are intended to be included within the scope of the present application and claims.

We claim:

1. A brush for applying viscous coatings to a surface, comprising:
a brush head with a plurality of bristles having a modulus of elasticity in the range of 2-4 GPa, a diameter in the range of 0.25 mm to 1.0 mm and a free length of 1.5-2.5 inches, an overall thickness in the range of 0.75 inch to 1.0 inch, a total bristle count of 2,500 to 3,500 and a width to thickness to height ratio in the range of 20:1.5:1.5 to 30:0.75:2.5.

2. The brush of claim 1, further comprising a handle attached to the brush head at an angle such that when the handle is held at an angle in the range of 10 to 40 degrees relative to the surface, a bottom surface of the brush head defined by the terminal ends of the plurality of bristles is substantially flat on the surface +/−15 degrees.

3. The brush of claim 2, wherein an inner angle between the handle and the brush head is about 120 degrees.

4. The brush of claim 3, wherein the brush head has a root portion with upper and lower portions, the lower portion attached to the bristles, the upper portion disposed at an inside angle of about 150 degrees relative to the lower portion, the handle connecting to and forming an angle of approximately 90 degrees relative to the upper portion.

5. The brush of claim 4, wherein the bristles are bent around a wire and crimped in a frame, the frame being attached to the root portion.

6. The brush of claim 5, wherein the bristles are nylon.

7. The brush of claim 6, further comprising a support web extending between the handle and the brush head.

8. The brush of claim 7, wherein an inside angle between the bristles and the handle is about 120 degrees.

9. The brush of claim 8, wherein the brush head is attached to the handle by a tab and mating slot.

10. The brush of claim 1, wherein the brush head is attached to the handle by a mating sleeve and cylinder.

11. The brush of claim 1, wherein the brush head has a clamp for removably retaining a crimped metal frame in which the bristles are retained, the clamp removably attaching to the handle.

12. The brush of claim 1, wherein the brush head is attached to the handle by a mating threaded end of the handle received in a threaded aperture in the brush head.

13. The brush of claim 1, wherein the brush is capable of applying coatings in the viscosity range of 2,500 CPS to 15,000 CPS.

14. The brush of claim 13, wherein the film of the coating applied when the brush has an applied downforce of about 2 to 10 lbs. is between 25 to 50 mils.

15. The brush of claim 14, wherein the brush is capable of applying an even coating to a surface which has a roughness of about ⅛ inch without skips.

16. The brush of claim 2, wherein the bottom surface of the brush head has a surface area of about 18 inches².

17. The brush of claim 16, wherein the bottom surface of the brush is substantially parallel to the surface to which the coating is applied when the handle is at 30 degrees relative to the surface to which the coating is applied.

18. The brush of claim 1, wherein the brush is capable of applying the viscous coating when pushed or pulled.

19. The brush of claim 5, wherein the root portion has an upper channel and a lower channel, the lower channel receiving the frame and the upper channel having a fastener that couples to a bracket on the handle.

20. The brush of claim 19, further comprising a frame fastener extending into the lower channel retaining the frame portion within the lower channel.
